(19) United States
(12) Patent Application Publication
(10) Pub. No.: US 2025/0190526 A1
(43) Pub. Date: Jun. 12, 2025

(54) TRAINING A PATTERN RECOGNITION SYSTEM

(71) Applicant: Cyberswarm, Inc., San Mateo, CA (US)

(72) Inventors: Viorel-Georgel DUMITRU, Ploiesti (RO); Andrei ILIESCU, Ploiesti (RO); Elena-Adelina DUCA, Ploiesti (RO); Lucian-Gabriel DINU, Ploiesti (RO)

(73) Assignee: Cyberswarm, Inc., San Mateo, CA (US)

(21) Appl. No.: 18/532,354

(22) Filed: Dec. 7, 2023

(51) Int. Cl. G06F 18/25; G06N 3/065

(52) U.S. Cl. CPC G06F 18/251; G06N 3/065

(57) ABSTRACT

An example method of training a pattern recognition system. The method may include inputting a voltage based on a pattern to a first set of rows and grounding a first column of the memristor columns via a resistor. The method may also include applying a first scaled voltage to a second column of the column pair, a second scaled voltage to remaining columns, and a third scaled voltage to a second set of rows different from the first set of rows.

### CROSS REFERENCE TO RELATED APPLICATIONS

This application is related to U.S. patent application Ser. No. 18/323,637, entitled “Pattern recognition system and method”, filed May 5, 2023, which is hereby incorporated by reference in its entirety. This application is also related to U.S. Pat. No. 10,902,914, entitled “Programmable resistive memory element and a method of making the same,” filed Jun. 4, 2019, and issued Jan. 26, 2021, which is hereby incorporated by reference in its entirety. This application is also related to U.S. Pat. No. 11,183,240, entitled “Programmable resistive memory element and a method of making the same,” filed Jan. 26, 2021, and issued Nov. 23, 2021, which is also hereby incorporated by reference in its entirety. This application is also related to U.S. patent application Ser. No. 18/048,594, entitled “Analog programmable resistive memory,” filed Oct. 21, 2022, which is also hereby incorporated by reference in its entirety.

### BACKGROUND

Pattern recognition is fundamental in developing artificial intelligence. Pattern recognition is usually performed using software-based artificial neural networks. Software-based artificial neural networks, however, require a lot of computational power and consume a lot of energy. Therefore, systems and methods that achieve pattern recognition with much less energy consumption and that can perform local processing of data without much external computational power are highly desirable. Such a system can be constructed using memristor arrays and electronic components based artificial neurons. This construction, however, requires sequential applications of patterns and their negatives to different memristor arrays. For example, a pattern is applied on a first memristor array or on a first memristor column and a negative of the pattern is subsequently applied on a second memristor array or on a second memristor column. Such training is complex because both the pattern and the negative of the pattern need to be converted first to corresponding input voltage values. The input voltage values are to be applied to different memristor arrays in a predetermined sequence.

As such, simpler and more efficient training methods for training memristor arrays are desired.

### SUMMARY

Embodiments disclosed herein solve the aforementioned technical problems and may provide other solutions as well. In one or more embodiments, a pattern recognition system formed using a memristor crossbar may be trained by applying different voltages to different portions of the memristor crossbar. For example, a column pair of the memristor crossbar may be configured to recognize a pattern. To adjust memristor resistance values of the column pair, a voltage may be applied on the memristor crossbar to a first set of rows corresponding to the pattern and to a first column of the column pair. A first scaled voltage (e.g., five-fourths of the voltage) may be applied to a second column of the column pair. A second scaled voltage (e.g., three-fourths of the voltage) may be applied to the remaining columns of the memristor crossbar. A third scaled voltage (e.g., half of the voltage) may be applied to a second set of rows different from the first set of rows. This training allows for the memristors from the first column of the column pair to change their resistance accordingly to the pattern and simultaneously allows for the memristors from the second column of the column pair to change their resistance accordingly to the negative of the pattern. Therefore, negative patterns and sequential applications of positive and negative patterns are not needed.

In one or more embodiments, a method of training a pattern recognition system is disclosed. The method may include inputting a voltage based on a pattern to a first set of rows in a memristor crossbar and grounding a first column of a column pair of memristors from the crossbar via a resistor. The method may also include applying a first scaled voltage to a second column of the column pair, a second scaled voltage to remaining columns, and a third scaled voltage to a second set of rows different from the first set of rows.

In one or more embodiments, a pattern recognition system is provided. The pattern recognition system may include a memristor crossbar comprising a plurality of columns and a plurality of rows, a first column and a second column of the plurality of columns forming a column pair. The column pair may be trained to recognize a pattern by inputting a voltage based on the pattern to a first set of rows of the plurality of rows, the first column being grounded via a resistor and applying a first scaled voltage to the second column, a second scaled voltage to remaining columns, and a third scaled voltage to a second set of rows of the plurality of columns and different from the first set of rows.

In one or more embodiments, a hardware based neural network is provided. The hardware based neural network may include one or more neural network layers formed by a plurality of memristors as network weights organized in a memristor crossbar having a plurality of columns and a plurality of rows, the neural network being trained to adjust one or more network weights to recognize a pattern. The training may include inputting a voltage based on a pattern to a first set of rows of the memristor crossbar and grounding a first column of a column pair via a resistor. The training may also include applying a first scaled voltage to a second column of the column pair, a second scaled voltage to remaining columns, and a third scaled voltage value to a second set of rows different from the first set of rows, such that the first voltage, the first scaled voltage, the second scaled voltage, and the third scaled voltage adjust network weights corresponding to memristor states of the column pair.

### BRIEF DESCRIPTION OF THE DRAWINGS

FIG. 1A depicts an example process of training a pattern recognition system, based on the principles disclosed herein.

FIG. 1B depicts an example process of deploying a trained pattern recognition system, based on the principles disclosed herein.

FIG. 1C depicts an example of an internal structure of an artificial neural shown in FIG. 1B, based on the principles disclosed herein.

FIG. 2 depicts a flowchart of an example method of training a pattern recognition system, based on the principles disclosed herein.

### DETAILED DESCRIPTION

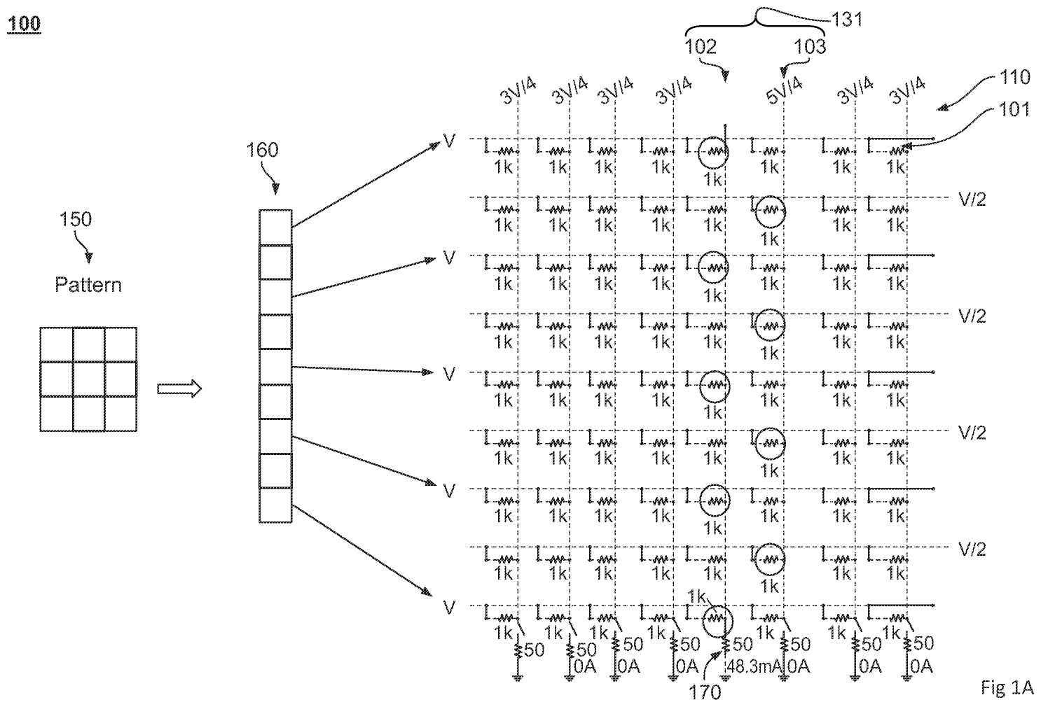

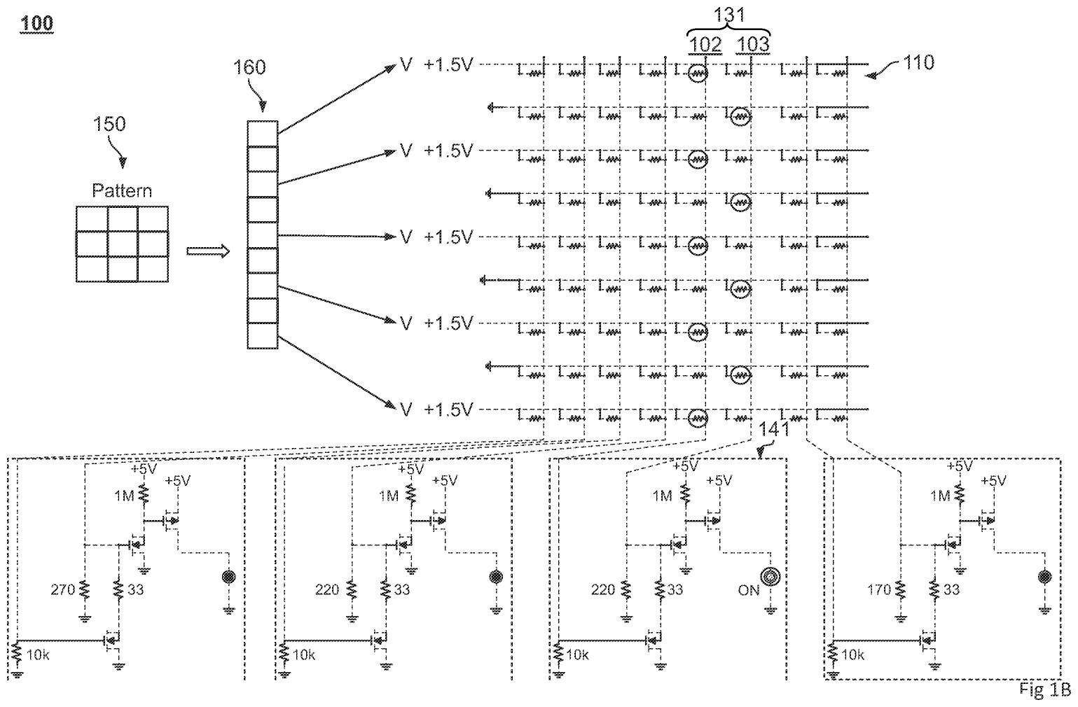

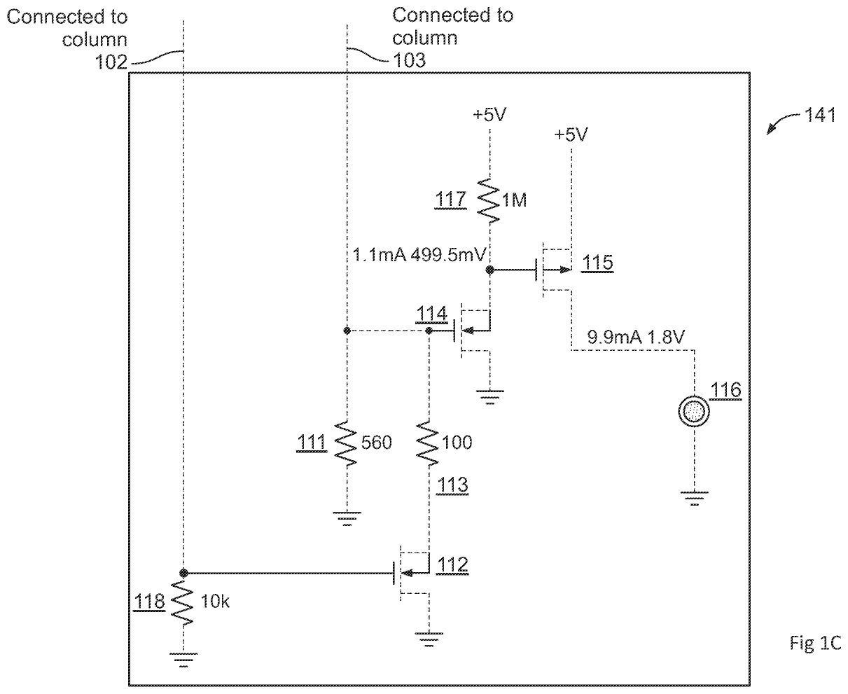

FIG. 1A depicts an example process of training a pattern recognition system 100, based on the principles disclosed herein. It should be understood that the pattern recognition system 100 and the process of its training are provided as examples and should not be considered limiting. That is, pattern recognition systems with additional, alternative, or fewer number of components; and training processes with alternative, additional, or fewer number of steps should be considered within the scope of this disclosure. The pattern recognition system 100 may form one or more layers of a hardware based neural network. For the hardware based neural network embodiments, the training may adjust network weights.

As shown, the pattern recognition system 100 incorporates a memristor crossbar 110 formed with memristors 101. The memristors 101 used in the memristor crossbar 110 may include different types of memristors. For instance, Indium gallium zinc oxide (IGZO) memristors with coplanar electrodes like those described in U.S. Pat. Nos. 10,902,914, 11,183,240, and U.S. patent application Ser. No. 18/048,594, all of which have been incorporated in their entirety by reference, can be used as the memristors 101. Within the memristor crossbar 110, different memristor columns may be formed. The memristor columns may be organized and configured in pairs. For instance, memristor columns 102, 103 may form a memristor column pair 131. This column-pair configuration is just an example, and any clustering of the memristors 101 within the memristor crossbar 110 should be considered within the scope of this disclosure. Furthermore, the electrodes of the memristors 101 may be situated on a same plane. The memristors 101 may be of different types and/or may have different resistances.

The pattern recognition system 100 may be trained with a pattern 150 such that the pattern recognition system 100 may detect the pattern 150 during deployment, e.g., as described with reference to FIG. 1B below. The pattern 150 may include any type of pattern, including, but not limited to, an image pattern, a video pattern, an audio pattern, a text pattern, and/or any type of organization of information. In one or more embodiments, the pattern 150 can be a raw pattern. In one or more embodiments, the pattern 150 may include various mathematical transformations (e.g., resize) of the raw pattern.

To train the pattern recognition system 100, the pattern 150 may be divided into parts or pixels, which may then be transformed in voltage input vector 160. In one or more embodiments, the voltage input vector 160 may be scaled up to obtain voltage values high enough to change the resistance of the memristors 101. That is, the resistances of the memristors 101 changed by applying the high voltages may subsequently be used to recognize the pattern 150.

Particularly, to modify resistances of memristors 101 in the memristor crossbar 110, high voltage values V from the voltage input vector 160 and corresponding to the pattern 150 may applied on the memristor crossbar 110 on a first set of rows. The first set of rows are selected based on the locations of the high voltage values (e.g., representing binary “1”). The memristor column 102 may be connected to ground via a resistor 170. On another memristor column 103 of the memristor column pair 131, another voltage value of 5V/4 may be applied. On the remaining columns, a voltage value of 3V/4 is applied. On a second set of rows—different from the first set of rows where the voltage value V is applied—a voltage value of V/2 is applied. In this schema, therefore, voltage value of V is applied to a first set of rows; the column 102 grounded via the resistor 170; a voltage value of 5V/4 is applied to the column 103; a voltage value of 3V/4 is applied to the remaining columns; and voltage value of V/2 is applied to the second set of rows. Such biasing schema allows the modification of the memristors 101 of the column 102 (connected to the ground) accordingly to the pattern 150. The memristors 101 from the memristor column 103, that are biased with 5V/4, are modified accordingly with the negative of the pattern 150 (e.g., simultaneously with the modification of the memristors 101 of the memristor column 102). In FIG. 1A, such a modification is indicated by circles around the corresponding memristors 101. As shown, the pattern of circles on the column 102 corresponds to the voltage input vector 160 (high, low, high, low, high, low, high, low, high). The pattern of circles on the column 103 corresponds to negative of the voltage input vector 160 (i.e., the pattern is low, high, low, high, low, high, low, high, low).

The memristors 101 from the column 103 indicated by circles are biased, accordingly with the FIG. 1A, with a 5V/4−V/2=3V/4 voltage that is high enough to change the resistances of the memristors 101. The memristors 101 from the column 103 that are not indicated by circles are biased, accordingly with FIG. 1A with a 5V/4−V=V/4 voltage that is not high enough to change the resistances of those memristors 101.

The memristors 101 from the column 102 indicated by circles are biased, accordingly with the FIG. 1A, with a V-VR, where VR is the voltage drop on the resistor 170, and is high enough to change the resistances of respective memristors 101. The memristors 101 from the column 102 that are not indicated by circles are biased, accordingly with FIG. 1A with a V/2-VR, and is not high enough to change the resistances of the respective memristors 101.

In one or more embodiments, the absolute values of voltages V may be chosen depending on the characteristics of the corresponding memristors 101.

It should be understood that the particular application of the voltage value V and scaled voltage values 5V/4, 3V/4, V/2 are just examples and should not be considered limiting, as long as the memristors 101 from the column 102 connected to the ground are changing accordingly to the pattern 150 and, simultaneously, the memristors 101 from the other column 103 are changing accordingly to the negative of the pattern 150. Applications of other scaled voltage values should also be considered within the scope of this disclosure. Additionally, for the hardware based neural networks, the modification of the resistances of the memristors 101 is an adjustment of the network weights of the hardware based neural networks.

In one or more embodiments, the memristors 101 (e.g., memristors 101 corresponding to high pattern) of the column 102 could be modified in steps until a certain stage of their resistance is reached. The modification in stages could be achieved by an adjustment of the resistor 170 without affecting the rest of the memristors 101.

In one or more embodiments, different pairs of columns from the memristor crossbar 110 could have different modification stages of the memristors, therefore obtaining different types of modification for every pair of columns. Different patterns could be learned in this way, using for each pattern a different pair of memristor columns (e.g., memristor column pair 131 for pattern 150 and other memristor column pairs for other patterns). Therefore, the memristor crossbar 110 can be trained to recognize multiple patterns, with each column pair (e.g., memristor column pair 131) recognizing a corresponding pattern that it is trained for.

FIG. 1B depicts an example process of deploying the pattern recognition system 100, based on the principles disclosed herein. That is, the pattern recognition system 100, trained to recognize the pattern 150, is now deployed to actually recognize the pattern 150 during operation of the system 100. When part of a hardware based neural network, the one or more layers formed by the pattern recognition system 100 may be deployed to recognize the pattern 150.

As shown, the pattern 150—now to be recognized—may be divided into parts or pixels, which may then be transformed in voltage input vector 160. In or more embodiments, the voltage input vector 160 may be scaled down to obtain voltage values low enough to not change the resistance of the memristors 101 (and potentially affect the trained pattern recognition capability) within the memristor crossbar 110.

The voltage input vector 160 may be applied to memristor crossbar 110 connected with artificial neurons (e.g., an artificial neuron 141) built using electronic components. For example, the memristor column pair 131 formed by memristor columns 102, 103 is connected to the artificial neuron 141. The input pins for rows other than the rows connected to voltage input V can be grounded. As described below, when the memristor column pair 131 recognizes the pattern 150, the artificial neuron 141 may provide an indication of such pattern recognition.

FIG. 1C shows an example internal structure of the artificial neuron 141, based on the principles disclosed herein. It should be understood that the shown internal structure is just an example, and artificial neurons with other types of internal structures should be considered within the scope of this disclosure.

As shown, the artificial neuron 141 may include resistors 118, 113 and a transistor 112 forming an inhibitory component. The artificial neuron 141 may further include resistors 111, 117 and transistors 114, 115 forming an excitatory component. The inhibitory component of the artificial neuron 141 may be configured to stop a triggering of the artificial neuron 141 when an output current of one of the memristor columns of the memristor column pair 131 reaches a certain maximum value established during the training process. The excitatory component of the artificial neuron 141 may be configured to trigger the artificial neuron 141 when an output current of another memristor column of the memristor column pair 131 reaches a certain minimum value established during the training process. The triggering of the artificial neuron 141 may mean that the transistor 115 is open allowing a current to flow through an indicator 116, thereby turning it on. It should be also noted that the indicator 116 could be replaced by the connection (e.g., to send an indication of the triggering) to the next layer of a hardware based neural network in which the described pattern recognition system 100 is part of one or more layers of the hardware based neural network.

In one or more embodiments, application of high voltage values corresponding to the pattern 150 during the training process may increase resistances of the corresponding memristors 101. In these cases, the memristor column 102 of the memristor column pair 131 (that was connected to the ground during the training process) may be connected to an inhibitory component of the artificial neuron 141 and the memristor column 103 of the memristor column pair 131 (that was connected to the 5V/4 during the training process) could be connected to the excitatory component of the artificial neuron 141.

In one or more embodiments, application of high voltage values corresponding to the pattern 150 during the training process may decrease resistances of the corresponding memristors 101. In these cases, the memristor column 102 of the memristor column pair 131 (that was connected to the ground during the training process) could be connected to the excitatory component of the artificial neuron 141 and the memristor column 103 of the pair memristor column pair 131 (that was connected to the 5V/4 during the training process) could be connected to the inhibitory component of the artificial neuron 141.

It should be noted, as described above, the different components forming the excitatory and the inhibitory parts shown in FIG. 1C are only for exemplification and other components (for instance, potentiometers instead of fixed resistors, memristors, or different kinds of transistors, etc.) could be also used to realize the excitatory and inhibitory functions described herein.

Furthermore, while the illustrated memristor crossbar 110 has 8 columns, each column containing nine individual memristors 101, it should be understood that this is only for exemplification and systems with a much large number of memristors, memristor columns, and artificial neurons could be built and operated in a similar way. That is, the specific numbers of memristors 101 for different levels of abstractions and organization (e.g., number of memristors 101 being connected to an artificial neuron) is just for an ease of explanation and should not be considered limiting.

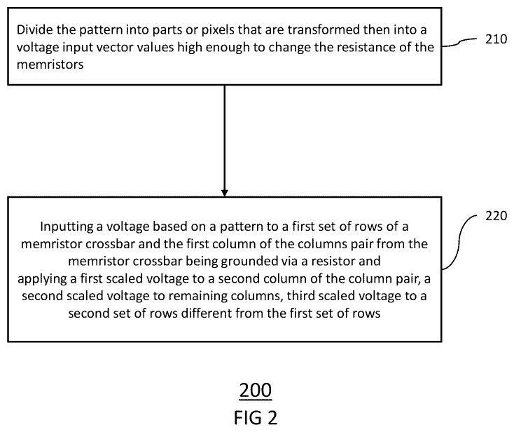

FIG. 2 depicts a flowchart of an example method 200 of training a pattern recognition system, based on the principles disclosed herein. It should be understood that the steps of the method 200 are just examples and should not be considered limiting. That is, methods with additional, alternative, or fewer number of steps should be considered within the scope of this disclosure. The pattern recognition system may include a memristor crossbar (e.g., memristor crossbar 110 shown in FIGS. 1A-1B).

The method may begin at step 210, where a voltage based on a pattern may be divided into parts or pixels and transformed into voltage vector values high enough to change the resistance of the memristors.

At step 220, the voltage input values may be applied to a first set of rows of a memristor crossbar and the first column of the columns pair from the memristor crossbar being grounded via a resistor; a first scaled voltage may be applied to a second column of the column pair, a second scaled voltage may be applied to remaining columns, third scaled voltage may be applied to a second set of rows different from the first set of rows. In one or more embodiments, the first scaled voltage may include five-fourths of the voltage (5V/4), the second scaled voltage may include three-fourths of the voltage (3V/4), and the third scaled voltage may include a half of the voltage (V/2).

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method of training a pattern recognition system, the method comprising:
inputting a voltage based on a pattern to a first set of rows in a memristor crossbar;
grounding a first column of a column pair of memristors from the crossbar via a resistor; and
applying a first scaled voltage to a second column of the column pair, a second scaled voltage to remaining columns, and a third scaled voltage to a second set of rows different from the first set of rows.

2. The method of claim 1, the inputting of the voltage causing memristors in the first column to change resistances according to the pattern, and the applying of the first scaled voltage causing memristors in the second column to change resistances according to the negative of the pattern.

3. The method of claim 2, the changing of the resistances of the memristors of the first column being simultaneous with the changing of the resistances of the memristors of the second column.

4. The method of claim 1, applying the first scaled voltage to the second column comprising:
applying five-fourths of the voltage to the second column.

5. The method of claim 1, applying the second scaled voltage to the remaining columns comprising:
applying three-fourths of the voltage to the remaining columns.

6. The method of claim 1, applying the third scaled voltage to the second set of rows comprising:
applying one-half of the voltage to the second set of rows.

7. The method of claim 1, further comprising:
training the pattern recognition system to recognize a second pattern on a second column pair.

8. The method of claim 1, the memristor crossbar comprising memristors of different resistances.

9. The method of claim 1, the memristor crossbar comprising memristors of different types.

10. The method of claim 1, further comprising:
configuring an artificial neuron connected to the column pair to trigger when the pattern is recognized by the column pair.

11. A pattern recognition system comprising:
a memristor crossbar comprising a plurality of columns and a plurality of rows, a first column and a second column of the plurality of columns forming a column pair, the column pair being trained to recognize a pattern by:
inputting a voltage based on the pattern to a first set of rows of the plurality of rows, the first column being grounded via a resistor; and
applying a first scaled voltage to the second column, a second scaled voltage to remaining columns, and a third scaled voltage to a second set of rows of the plurality of columns and different from the first set of rows.

12. The pattern recognition system of claim 11, further comprising:
an artificial neuron connected to the column pair and configured to be triggered when the pattern is recognized by the column pair.

13. The pattern recognition system of claim 12, the artificial neuron comprising:
an excitatory component configured to trigger the artificial neuron when a current output of one column of the column pair has a minimum value established during the training; and
an inhibitory component configured to stop the triggering of the artificial neuron when a current output of the other column of the column pair has a maximum value established during the training.

14. The pattern recognition system of claim 11, further comprising additional column pairs trained to recognize corresponding additional patterns.

15. The pattern recognition system of claim 11, the memristor crossbar comprising Indium gallium zinc oxide (IGZO) based memristors.

16. The pattern recognition system of claim 11, the memristor crossbar comprising memristors having electrodes situated on a same plane.

17. The pattern recognition system of claim 11, the memristor crossbar comprising memristors of different resistances.

18. The pattern recognition system of claim 11, the memristor crossbar comprising memristors of different types.

19. A hardware based neural network comprising:
one or more neural network layers formed by a plurality of memristors as network weights organized in a memristor crossbar having a plurality of columns and a plurality of rows, the neural network being trained to adjust one or more network weights to recognize a pattern, the training comprising:
inputting a voltage based on a pattern to a first set of rows of the memristor crossbar;
grounding a first column of a column pair via a resistor; and
applying a first scaled voltage to a second column of the column pair, a second scaled voltage to remaining columns, and a third scaled voltage value to a second set of rows different from the first set of rows,
such that the first voltage, the first scaled voltage, the second scaled voltage, and the third scaled voltage adjust network weights corresponding to memristor states of the column pair.

20. The hardware based neural network of claim 19, the neural network being trained to recognize more patterns by adjusting network weights corresponding to memristors of more column pairs of the memristor crossbar.
